(19) United States
(12) Patent Application Publication
(10) Pub. No.: US 2018/0211413 A1
(43) Pub. Date: Jul. 26, 2018

(54) IMAGE SIGNAL PROCESSING USING SUB-THREE-DIMENSIONAL LOOK-UP TABLES

(71) Applicant: GoPro, Inc., San Mateo, CA (US)

(72) Inventors: Thomas Nicolas Emmanuel Veit, Meudon (FR); Bruno Cesar Douady-Pleven, Bures-sur-Yvette (FR); Guillaume Matthieu Guérin, Paris (FR)

(21) Appl. No.: 15/439,281

(22) Filed: Feb. 22, 2017

Related U.S. Application Data
(60) Provisional application No. 62/450,744, filed on Jan. 26, 2017.

(51) Int. Cl. G06T 7/90; H04N 9/04; H04N 9/73; H04N 1/60

(52) U.S. Cl. CPC G06T 7/90; H04N 9/04; H04N 9/735; H04N 2101/00; G06T 2207/10024; G06T 2207/10016; H04N 1/6008

(57) ABSTRACT

Obtaining color adjusted image portions using sub-three-dimensional look-up tables may include obtaining the color adjusted image portion by obtaining a value for an input image portion wherein the value includes a first parameter, a second parameter, and a third parameter, obtaining a color adjusted first parameter from at least a first one-dimensional look-up table based on the first parameter, the second parameter, and the third parameter, obtaining a color adjusted second parameter from at least a second one-dimensional look-up table based on the first parameter, the second parameter, and the third parameter, obtaining a color adjusted third parameter from at least a third one-dimensional look-up table based on the first parameter, the second parameter, and the third parameter, and outputting the color adjusted image portion based on a combination of the color adjusted first parameter, the color adjusted second parameter, and the color adjusted third parameter.

### CROSS-REFERENCE TO RELATED APPLICATION(S)

This application claims priority to U.S. Provisional Patent Application No. 62/450,744, filed Jan. 26, 2017, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present disclosure relates to digital image and video processing, including temporal and spatial image noise reduction, local motion compensation, spatially combining images, image distortion compensation, bitrate allocation, image alignment, and prevention of highlight clipping.

### BACKGROUND

Image capture devices, such as cameras, may capture content as images or video. Light may be received and focused via a lens and may be converted to an electronic image signal by an image sensor. The image signal may be processed by an image signal processor (ISP) to form an image, which may be stored and/or encoded. In some implementations, multiple images or video frames may include spatially adjacent or overlapping content. Accordingly, systems, methods, and apparatus for capturing, processing, and/or encoding images, video, or both may be advantageous.

### SUMMARY

The present disclosure satisfies the foregoing needs by providing, inter alia, apparatus and methods for image signal processing using sub-three-dimensional look-up tables.

An aspect of the disclosure relates to a non-transitory computer-readable storage medium. In an implementation, the non-transitory computer-readable storage medium comprises instructions that, when executed by a processor, implement performance of operations, including receiving an input image, obtaining an input image portion from the input image, and obtaining a color adjusted image portion based on the input image portion by obtaining a value for the input image portion wherein the value is expressed as a combination of at least a first parameter, a second parameter, and a third parameter, obtaining a color adjusted first parameter from at least a first one-dimensional look-up table based on the first parameter, the second parameter, and the third parameter, obtaining a color adjusted second parameter from at least a second one-dimensional look-up table based on the first parameter, the second parameter, and the third parameter, obtaining a color adjusted third parameter from at least a third one-dimensional look-up table based on the first parameter, the second parameter, and the third parameter, and outputting the color adjusted image portion based on a combination of the color adjusted first parameter, the color adjusted second parameter, and the color adjusted third parameter. The operations may include including the color adjusted image portion in a color adjusted image, and transmitting or storing the color adjusted image.

Another aspect of the disclosure relates to an apparatus. In an implementation, the apparatus comprises an image signal processor configured to receive an input image, obtain an input image portion from the input image, obtain a value for the input image portion wherein the value is expressed as a combination of at least a first parameter, a second parameter, and a third parameter, obtain a color adjusted first parameter from at least a first one-dimensional look-up table based on the first parameter, the second parameter, and the third parameter, obtain a color adjusted second parameter from at least a second one-dimensional look-up table based on the first parameter, the second parameter, and the third parameter, obtain a color adjusted third parameter from at least a third one-dimensional look-up table based on the first parameter, the second parameter, and the third parameter, obtain a color adjusted image portion based on a combination of the color adjusted first parameter, the color adjusted second parameter, and the color adjusted third parameter, include the color adjusted image portion in a color adjusted image, and transmit or store the color adjusted image.

Another aspect of the disclosure relates to a method. In an implementation, the method comprises an image signal processor executing instructions stored on a non-transitory computer-readable storage medium, and includes receiving an input image, obtaining an input image portion from the input image, obtaining a color adjusted image portion based on the input image portion, including the color adjusted image portion in a color adjusted image, and transmitting or storing the color adjusted image. Obtaining the color adjusted image portion based on the input image portion includes obtaining a value for the input image portion wherein the value is expressed as a combination of at least a first parameter, a second parameter, and a third parameter, obtaining a first component of a first color adjusted parameter from a first one-dimensional look-up table based on the first parameter, obtaining a second component of the first color adjusted parameter from a second one-dimensional look-up table based on the second parameter, obtaining a third component of the first color adjusted parameter from a third one-dimensional look-up table based on the third parameter, obtaining a mathematical combination of the first component of the first color adjusted parameter, the second component of the first color adjusted parameter, and the third component of the first color adjusted parameter as a first color adjusted parameter obtaining a first component of a second color adjusted parameter from a fourth one-dimensional look-up table based on the first parameter, obtaining a second component of the second color adjusted parameter from a fifth one-dimensional look-up table based on the second parameter, obtaining a third component of the second color adjusted parameter from a sixth one-dimensional look-up table based on the third parameter, obtaining a mathematical combination of the first component of the second color adjusted parameter, the second component of the second color adjusted parameter, and the third component of the second color adjusted parameter as a second color adjusted parameter, obtaining a first component of a third color adjusted parameter from a seventh one-dimensional look-up table based on the first parameter, obtaining a second component of the third color adjusted parameter from a eighth one-dimensional look-up table based on the second parameter, obtaining a third component of the third color adjusted parameter from a ninth one-dimensional look-up table based on the third parameter. obtaining a mathematical combination of the first component of the third color adjusted parameter, the second component of the third color adjusted parameter, and the third component of the third color adjusted parameter as a third color adjusted parameter, and obtaining the color adjusted image portion based on a combination of the first color adjusted parameter, the second color adjusted parameter, and the third color adjusted parameter.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular forms of “a,” “an,” and “the” include plural referents unless the context clearly dictates otherwise.

### BRIEF DESCRIPTION OF THE DRAWINGS

The disclosed embodiments have other advantages and features which will be more readily apparent from the detailed description, the appended claims, and the accompanying figures. A brief introduction of the figures is below.

FIG. 1 is a diagram of an example of an image capture system for content capture in accordance with implementations of this disclosure.

FIG. 2 is a block diagram of an example of an image capture device in accordance with implementations of this disclosure.

FIG. 3 is a cross-sectional view of an example of an image capture apparatus including overlapping fields-of-view in accordance with implementations of this disclosure.

FIG. 4 is a block diagram of an example of an image processing and coding pipeline in accordance with implementations of this disclosure.

FIG. 5 is a functional block diagram of an example of an image signal processor in accordance with implementations of this disclosure.

FIG. 6 is a diagram of an example of obtaining a color adjusted image portion using a three-dimensional look-up table in accordance with implementations of this disclosure.

FIG. 7 is a diagram of an example of a representation of a three-dimensional look-up table in accordance with implementations of this disclosure.

FIG. 8 is a diagram of an example of a representation of a portion (cube) of a three-dimensional look-up table in accordance with implementations of this disclosure.

FIG. 9 is a diagram of an example of obtaining a color adjusted image portion using sub-three-dimensional look-up tables in accordance with implementations of this disclosure.

All figures disclosed herein are © Copyright 2017 GoPro Inc. All rights reserved.

### DETAILED DESCRIPTION

Implementations of the present technology will now be described in detail with reference to the drawings, which are provided as examples so as to enable those skilled in the art to practice the technology. The figures and examples are not meant to limit the scope of the present disclosure to a single implementation or embodiment, and other implementations and embodiments are possible by way of interchange of, or combination with, some or all of the described or illustrated elements. Wherever convenient, the same reference numbers will be used throughout the drawings to refer to same or like parts.

Content, such as visual content, may be captured as one or more images or video frames by one or more image capture devices, such as a camera or camera array. An image capture device may include one or more lenses, image sensors, image signal processors, encoders, or combinations thereof. A lens may receive and focus light on an image sensor or sensors. An image sensor or sensors may sample the light and generate an electronic image signal. An image signal processor (ISP) may receive the image signal from one or more sensors and may process the image signal to generate an image, picture, or frame.

Processing the image signal may include adjusting color values for one or more portions, such as one or more pixels, of the input image. In some embodiments, adjusting the color values for a portion, such as a pixel, of the input image may include using a three-dimensional look-up table. However, using a three-dimensional look-up table may utilize significant processing or memory resources.

Image signal processing including obtaining color adjusted image portions using sub-three-dimensional look-up tables may utilize fewer resources than using a three-dimensional look-up table. Obtaining color adjusted image portions using sub-three-dimensional look-up tables may include using multiple one-dimensional look-up tables, such as nine one-dimensional look-up tables, each including sixteen values, which may include storing 144 values (9*16=144).

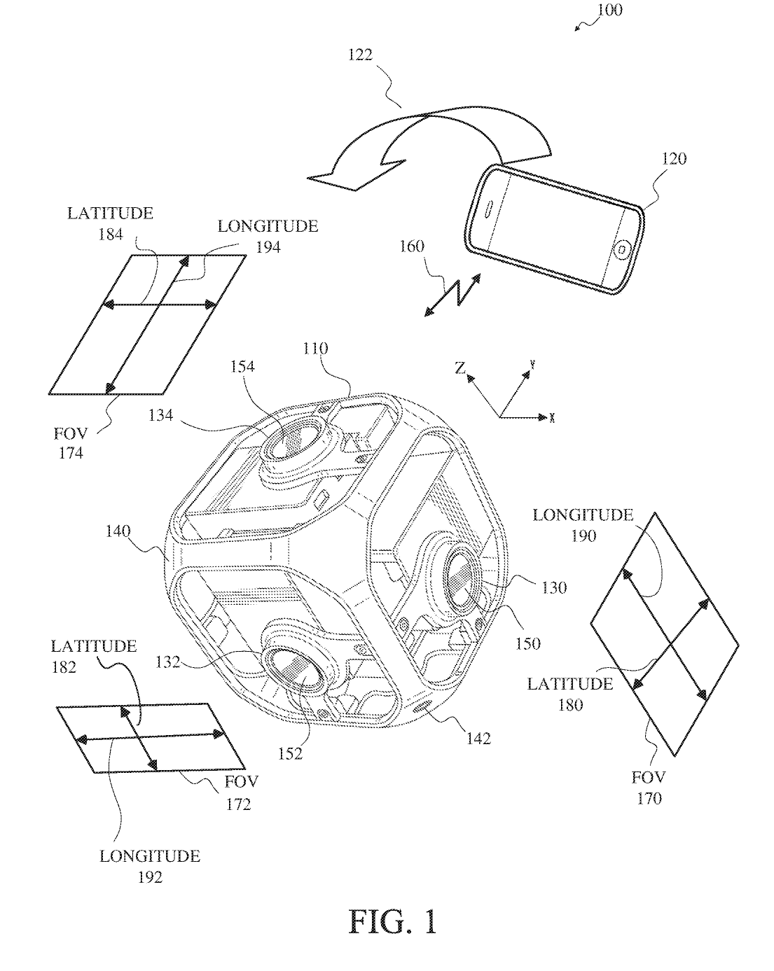

FIG. 1 is a diagram of an example of an image capture system 100 for content capture in accordance with implementations of this disclosure. As shown in FIG. 1, an image capture system 100 may include an image capture apparatus 110, an external user interface (UI) device 120, or a combination thereof.

In some implementations, the image capture apparatus 110 may be a multi-face apparatus and may include multiple image capture devices, such as image capture devices 130, 132, 134 as shown in FIG. 1, arranged in a structure 140, such as a cube-shaped cage as shown. Although three image capture devices 130, 132, 134 are shown for simplicity in FIG. 1, the image capture apparatus 110 may include any number of image capture devices. For example, the image capture apparatus 110 shown in FIG. 1 may include six cameras, which may include the three image capture devices 130, 132, 134 shown and three cameras not shown.

In some implementations, the structure 140 may have dimensions, such as between 25 mm and 150 mm. For example, the length of each side of the structure 140 may be 105 mm. The structure 140 may include a mounting port 142, which may be removably attachable to a supporting structure, such as a tripod, a photo stick, or any other camera mount (not shown). The structure 140 may be a rigid support structure, such that the relative orientation of the image capture devices 130, 132, 134 of the image capture apparatus 110 may be maintained in relatively static or fixed alignment, except as described herein.

The image capture apparatus 110 may obtain, or capture, image content, such as images, video, or both, with a 360° field-of-view, which may be referred to herein as panoramic or spherical content. For example, each of the image capture devices 130, 132, 134 may include respective lenses, for receiving and focusing light, and respective image sensors for converting the received and focused light to an image signal, such as by measuring or sampling the light, and the multiple image capture devices 130, 132, 134 may be arranged such that respective image sensors and lenses capture a combined field-of-view characterized by a spherical or near spherical field-of-view.

In some implementations, each of the image capture devices 130, 132, 134 may have a respective field-of-view 170, 172, 174, such as a field-of-view 170, 172, 174 that 90° in a lateral dimension 180, 182, 184 and includes 120° in a longitudinal dimension 190, 192, 194. In some implementations, image capture devices 130, 132, 134 having overlapping fields-of-view 170, 172, 174, or the image sensors thereof, may be oriented at defined angles, such as at 90°, with respect to one another. In some implementations, the image sensor of the image capture device 130 is directed along the X axis, the image sensor of the image capture device 132 is directed along the Y axis, and the image sensor of the image capture device 134 is directed along the Z axis. The respective fields-of-view 170, 172, 174 for adjacent image capture devices 130, 132, 134 may be oriented to allow overlap for a stitching function. For example, the longitudinal dimension 190 of the field-of-view 170 for the image capture device 130 may be oriented at 90° with respect to the lateral dimension 184 of the field-of-view 174 for the image capture device 134, the lateral dimension 180 of the field-of-view 170 for the image capture device 130 may be oriented at 90° with respect to the longitudinal dimension 192 of the field-of-view 172 for the image capture device 132, and the lateral dimension 182 of the field-of-view 172 for the image capture device 132 may be oriented at 90° with respect to the longitudinal dimension 194 of the field-of-view 174 for the image capture device 134.

The image capture apparatus 110 shown in FIG. 1 may have 420° angular coverage in vertical and/or horizontal planes by the successive overlap of 90°, 120°, 90°, 120° respective fields-of-view 170, 172, 174 (not all shown) for four adjacent image capture devices 130, 132, 134 (not all shown). For example, fields-of-view 170, 172 for the image capture devices 130, 132 and fields-of-view (not shown) for two image capture devices (not shown) opposite the image capture devices 130, 132 respectively may be combined to provide 420° angular coverage in a horizontal plane. In some implementations, the overlap between fields-of-view of image capture devices 130, 132, 134 having a combined field-of-view including less than 360° angular coverage in a vertical and/or horizontal plane may be aligned and merged or combined to produce a panoramic image. For example, the image capture apparatus 110 may be in motion, such as rotating, and source images captured by at least one of the image capture devices 130, 132, 134 may be combined to form a panoramic image. As another example, the image capture apparatus 110 may be stationary, and source images captured contemporaneously by each image capture device 130, 132, 134 may be combined to form a panoramic image.

In some implementations, an image capture device 130, 132, 134 may include a lens 150, 152, 154 or other optical element. An optical element may include one or more lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optical element. In some implementations, a lens 150, 152, 154 may be a fisheye lens and produce fisheye, or near-fisheye, field-of-view images. For example, the respective lenses 150, 152, 154 of the image capture devices 130, 132, 134 may be fisheye lenses. In some implementations, images captured by two or more image capture devices 130, 132, 134 of the image capture apparatus 110 may be combined by stitching or merging fisheye projections of the captured images to produce an equirectangular planar image. For example, a first fisheye image may be a round or elliptical image, and may be transformed to a first rectangular image, a second fisheye image may be a round or elliptical image, and may be transformed to a second rectangular image, and the first and second rectangular images may be arranged side-by-side, which may include overlapping, and stitched together to form the equirectangular planar image.

Although not expressly shown in FIG. 1, In some implementations, an image capture device 130, 132, 134 may include one or more image sensors, such as a charge-coupled device (CCD) sensor, an active pixel sensor (APS), a complementary metal-oxide semiconductor (CMOS) sensor, an N-type metal-oxide-semiconductor (NMOS) sensor, and/or any other image sensor or combination of image sensors.

Although not expressly shown in FIG. 1, In some implementations, an image capture apparatus 110 may include one or more microphones, which may receive, capture, and record audio information, which may be associated with images acquired by the image sensors.

Although not expressly shown in FIG. 1, the image capture apparatus 110 may include one or more other information sources or sensors, such as an inertial measurement unit (IMU), a global positioning system (GPS) receiver component, a pressure sensor, a temperature sensor, a heart rate sensor, or any other unit, or combination of units, that may be included in an image capture apparatus.

In some implementations, the image capture apparatus 110 may interface with or communicate with an external device, such as the external user interface (UI) device 120, via a wired (not shown) or wireless (as shown) computing communication link 160. Although a single computing communication link 160 is shown in FIG. 1 for simplicity, any number of computing communication links may be used. Although the computing communication link 160 shown in FIG. 1 is shown as a direct computing communication link, an indirect computing communication link, such as a link including another device or a network, such as the internet, may be used. In some implementations, the computing communication link 160 may be a Wi-Fi link, an infrared link, a Bluetooth (BT) link, a cellular link, a ZigBee link, a near field communications (NFC) link, such as an ISO/IEC 23243 protocol link, an Advanced Network Technology interoperability (ANT+) link, and/or any other wireless communications link or combination of links. In some implementations, the computing communication link 160 may be an HDMI link, a USB link, a digital video interface link, a display port interface link, such as a Video Electronics Standards Association (VESA) digital display interface link, an Ethernet link, a Thunderbolt link, and/or other wired computing communication link.

In some implementations, the user interface device 120 may be a computing device, such as a smartphone, a tablet computer, a phablet, a smart watch, a portable computer, and/or another device or combination of devices configured to receive user input, communicate information with the image capture apparatus 110 via the computing communication link 160, or receive user input and communicate information with the image capture apparatus 110 via the computing communication link 160.

In some implementations, the image capture apparatus 110 may transmit images, such as panoramic images, or portions thereof, to the user interface device 120 via the computing communication link 160, and the user interface device 120 may store, process, display, or a combination thereof the panoramic images.

In some implementations, the user interface device 120 may display, or otherwise present, content, such as images or video, acquired by the image capture apparatus 110. For example, a display of the user interface device 120 may be a viewport into the three-dimensional space represented by the panoramic images or video captured or created by the image capture apparatus 110.

In some implementations, the user interface device 120 may communicate information, such as metadata, to the image capture apparatus 110. For example, the user interface device 120 may send orientation information of the user interface device 120 with respect to a defined coordinate system to the image capture apparatus 110, such that the image capture apparatus 110 may determine an orientation of the user interface device 120 relative to the image capture apparatus 110. Based on the determined orientation, the image capture apparatus 110 may identify a portion of the panoramic images or video captured by the image capture apparatus 110 for the image capture apparatus 110 to send to the user interface device 120 for presentation as the viewport. In some implementations, based on the determined orientation, the image capture apparatus 110 may determine the location of the user interface device 120 and/or the dimensions for viewing of a portion of the panoramic images or video.

In an example, a user may rotate (sweep) the user interface device 120 through an arc or path 122 in space, as indicated by the arrow shown at 122 in FIG. 1. The user interface device 120 may communicate display orientation information to the image capture apparatus 110 using a communication interface such as the computing communication link 160. The image capture apparatus 110 may provide an encoded bitstream to enable viewing of a portion of the panoramic content corresponding to a portion of the environment of the display location as the image capture apparatus 110 traverses the path 122. Accordingly, display orientation information from the user interface device 120 may be transmitted to the image capture apparatus 110 to control user selectable viewing of captured images and/or video.

In some implementations, the image capture apparatus 110 may communicate with one or more other external devices (not shown) via wired or wireless computing communication links (not shown).

In some implementations, data, such as image data, audio data, and/or other data, obtained by the image capture apparatus 110 may be incorporated into a combined multimedia stream. For example, the multimedia stream may include a video track and/or an audio track. As another example, information from various metadata sensors and/or sources within and/or coupled to the image capture apparatus 110 may be processed to produce a metadata track associated with the video and/or audio track. The metadata track may include metadata, such as white balance metadata, image sensor gain metadata, sensor temperature metadata, exposure time metadata, lens aperture metadata, bracketing configuration metadata and/or other parameters. In some implementations, a multiplexed stream may be generated to incorporate a video and/or audio track and one or more metadata tracks.

In some implementations, the user interface device 120 may implement or execute one or more applications, such as GoPro Studio, GoPro App, or both, to manage or control the image capture apparatus 110. For example, the user interface device 120 may include an application for controlling camera configuration, video acquisition, video display, or any other configurable or controllable aspect of the image capture apparatus 110.

In some implementations, the user interface device 120, such as via an application (e.g., GoPro App), may generate and share, such as via a cloud-based or social media service, one or more images, or short video clips, such as in response to user input.

In some implementations, the user interface device 120, such as via an application (e.g., GoPro App), may remotely control the image capture apparatus 110, such as in response to user input.

In some implementations, the user interface device 120, such as via an application (e.g., GoPro App), may display unprocessed or minimally processed images or video captured by the image capture apparatus 110 contemporaneously with capturing the images or video by the image capture apparatus 110, such as for shot framing, which may be referred to herein as a live preview, and which may be performed in response to user input.

In some implementations, the user interface device 120, such as via an application (e.g., GoPro App), may mark one or more key moments contemporaneously with capturing the images or video by the image capture apparatus 110, such as with a HiLight Tag, such as in response to user input.

In some implementations, the user interface device 120, such as via an application (e.g., GoPro App), may display, or otherwise present, marks or tags associated with images or video, such as HiLight Tags, such as in response to user input. For example, marks may be presented in a GoPro Camera Roll application for location review and/or playback of video highlights.

In some implementations, the user interface device 120, such as via an application (e.g., GoPro App), may wirelessly control camera software, hardware, or both. For example, the user interface device 120 may include a web-based graphical interface accessible by a user for selecting a live or previously recorded video stream from the image capture apparatus 110 for display on the user interface device 120.

In some implementations, the user interface device 120 may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture apparatus 110.

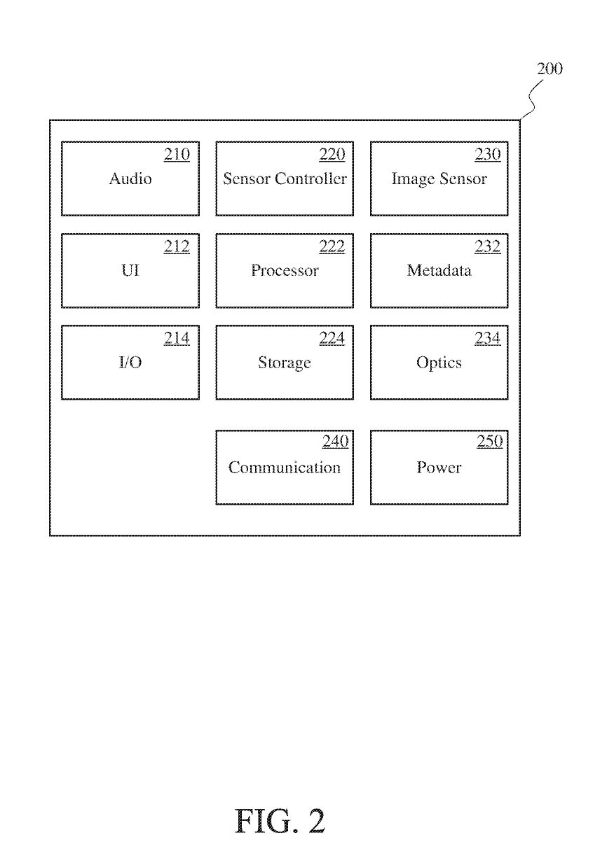

FIG. 2 is a block diagram of an example of an image capture device 200 in accordance with implementations of this disclosure. In some implementations, an image capture device 200, such as one of the image capture devices 130, 132, 134 shown in FIG. 1, which may be an action camera, may include an audio component 210, a user interface (UI) unit 212, an input/output (I/O) unit 214, a sensor controller 220, a processor 222, an electronic storage unit 224, an image sensor 230, a metadata unit 232, an optics unit 234, a communication unit 240, a power system 250, or a combination thereof.

In some implementations, the audio component 210, which may include a microphone, may receive, sample, capture, record, or a combination thereof audio information, such as sound waves, which may be associated with, such as stored in association with, image or video content contemporaneously captured by the image capture device 200. In some implementations, audio information may be encoded using, e.g., Advanced Audio Coding (AAC), Audio Compression-3 (AC3), Moving Picture Experts Group Layer-3 Audio (MP3), linear Pulse Code Modulation (PCM), Motion Picture Experts Group-High efficiency coding and media delivery in heterogeneous environments (MPEG-H), and/or other audio coding formats (audio codecs). In one or more implementations of spherical video and/or audio, the audio codec may include a three-dimensional audio codec, such as Ambisonics. For example, an Ambisonics codec can produce full surround audio including a height dimension. Using a G-format Ambisonics codec, a special decoder may be omitted.

In some implementations, the user interface unit 212 may include one or more units that may register or receive input from and/or present outputs to a user, such as a display, a touch interface, a proximity sensitive interface, a light receiving/emitting unit, a sound receiving/emitting unit, a wired/wireless unit, and/or other units. In some implementations, the user interface unit 212 may include a display, one or more tactile elements (e.g., buttons and/or virtual touch screen buttons), lights (LEDs), speakers, and/or other user interface elements. The user interface unit 212 may receive user input and/or provide information to a user related to the operation of the image capture device 200.

In some implementations, the user interface unit 212 may include a display unit that presents information related to camera control or use, such as operation mode information (e.g., image resolution, frame rate, capture mode, sensor mode, video mode, photo mode), connection status information (e.g., connected, wireless, wired connection), power mode information (e.g., standby mode, sensor mode, video mode), information related to other information sources (e.g., heart rate, GPS), and/or other information.

In some implementations, the user interface unit 212 may include a user interface component such as one or more buttons, which may be operated, such as by a user, to control camera operations, such as to start, stop, pause, and/or resume sensor and/or content capture. The camera control associated with respective user interface operations may be defined. For example, the camera control associated with respective user interface operations may be defined based on the duration of a button press (pulse width modulation), a number of button presses (pulse code modulation), or a combination thereof. In an example, a sensor acquisition mode may be initiated in response to detecting two short button presses. In another example, the initiation of a video mode and cessation of a photo mode, or the initiation of a photo mode and cessation of a video mode, may be triggered (toggled) in response to a single short button press. In another example, video or photo capture for a given time duration or a number of frames (burst capture) may be triggered in response to a single short button press. Other user command or communication implementations may also be implemented, such as one or more short or long button presses.

In some implementations, the I/O unit 214 may synchronize the image capture device 200 with other cameras and/or with other external devices, such as a remote control, a second image capture device, a smartphone, a user interface device, such as the user interface device 120 shown in FIG. 1, and/or a video server. The I/O unit 214 may communicate information between I/O components. In some implementations, the I/O unit 214 may be connected to the communication unit 240 to provide a wired and/or wireless communications interface (e.g., Wi-Fi, Bluetooth, USB, HDMI, Wireless USB, Near Field Communication (NFC), Ethernet, a radio frequency transceiver, and/or other interfaces) for communication with one or more external devices, such as a user interface device, such as the user interface device 120 shown in FIG. 1, or another metadata source. In some implementations, the I/O unit 214 may interface with LED lights, a display, a button, a microphone, speakers, and/or other I/O components. In some implementations, the I/O unit 214 may interface with an energy source, e.g., a battery, and/or a Direct Current (DC) electrical source.

In some implementations, the I/O unit 214 of the image capture device 200 may include one or more connections to external computerized devices for configuration and/or management of remote devices, as described herein. The I/O unit 214 may include any of the wireless or wireline interfaces described herein, and/or may include customized or proprietary connections for specific applications.

In some implementations, the sensor controller 220 may operate or control the image sensor 230, such as in response to input, such as user input. In some implementations, the sensor controller 220 may receive image and/or video input from the image sensor 230 and may receive audio information from the audio component 210.

In some implementations, the processor 222 may include a system on a chip (SOC), microcontroller, microprocessor, CPU, DSP, application-specific integrated circuit (ASIC), GPU, and/or other processor that may control the operation and functionality of the image capture device 200. In some implementations, the processor 222 may interface with the sensor controller 220 to obtain and process sensory information for, e.g., object detection, face tracking, stereo vision, and/or other image processing.

In some implementations, the sensor controller 220, the processor 222, or both may synchronize information received by the image capture device 200. For example, timing information may be associated with received sensor data, and metadata information may be related to content (photo/video) captured by the image sensor 230 based on the timing information. In some implementations, the metadata capture may be decoupled from video/image capture. For example, metadata may be stored before, after, and in-between the capture, processing, or storage of one or more video clips and/or images.

In some implementations, the sensor controller 220, the processor 222, or both may evaluate or process received metadata and may generate other metadata information. For example, the sensor controller 220 may integrate the received acceleration information to determine a velocity profile for the image capture device 200 concurrent with recording a video. In some implementations, video information may include multiple frames of pixels and may be encoded using an encoding method (e.g., H.262, H.264, CineForm and/or other codec).

Although not shown separately in FIG. 2, one or more of the audio component 210, the user interface unit 212, the I/O unit 214, the sensor controller 220, the processor 222, the electronic storage unit 224, the image sensor 230, the metadata unit 232, the optics unit 234, the communication unit 240, or the power systems 250 of the image capture device 200 may communicate information, power, or both with one or more other units, such as via an electronic communication pathway, such as a system bus. For example, the processor 222 may interface with the audio component 210, the user interface unit 212, the I/O unit 214, the sensor controller 220, the electronic storage unit 224, the image sensor 230, the metadata unit 232, the optics unit 234, the communication unit 240, or the power systems 250 via one or more driver interfaces and/or software abstraction layers. In some implementations, one or more of the units shown in FIG. 2 may include a dedicated processing unit, memory unit, or both (not shown). In some implementations, one or more components may be operable by one or more other control processes. For example, a GPS receiver may include a processing apparatus that may provide position and/or motion information to the processor 222 in accordance with a defined schedule (e.g., values of latitude, longitude, and elevation at 10 Hz).

In some implementations, the electronic storage unit 224 may include a system memory module that may store executable computer instructions that, when executed by the processor 222, perform various functionalities including those described herein. For example, the electronic storage unit 224 may be a non-transitory computer-readable storage medium, which may include executable instructions, and a processor, such as the processor 222 may execute the instruction to perform one or more, or portions of one or more, of the operations described herein. The electronic storage unit 224 may include storage memory for storing content (e.g., metadata, images, audio) captured by the image capture device 200.

In some implementations, the electronic storage unit 224 may include non-transitory memory for storing configuration information and/or processing code for video information and metadata capture, and/or to produce a multimedia stream that may include video information and metadata in accordance with the present disclosure. In some implementations, the configuration information may include capture type (video, still images), image resolution, frame rate, burst setting, white balance, recording configuration (e.g., loop mode), audio track configuration, and/or other parameters that may be associated with audio, video, and/or metadata capture. In some implementations, the electronic storage unit 224 may include memory that may be used by other hardware/firmware/software elements of the image capture device 200.

In some implementations, the image sensor 230 may include one or more of a charge-coupled device sensor, an active pixel sensor, a complementary metal-oxide semiconductor sensor, an N-type metal-oxide-semiconductor sensor, and/or another image sensor or combination of image sensors. In some implementations, the image sensor 230 may be controlled based on control signals from a sensor controller 220.

The image sensor 230 may sense or sample light waves gathered by the optics unit 234 and may produce image data or signals. The image sensor 230 may generate an output signal conveying visual information regarding the objects or other content corresponding to the light waves received by the optics unit 234. The visual information may include one or more of an image, a video, and/or other visual information.

In some implementations, the image sensor 230 may include a video sensor, an acoustic sensor, a capacitive sensor, a radio sensor, a vibrational sensor, an ultrasonic sensor, an infrared sensor, a radar sensor, a Light Detection And Ranging (LIDAR) sensor, a sonar sensor, or any other sensory unit or combination of sensory units capable of detecting or determining information in a computing environment.

In some implementations, the metadata unit 232 may include sensors such as an IMU, which may include one or more accelerometers and/or gyroscopes, a magnetometer, a compass, a GPS sensor, an altimeter, an ambient light sensor, a temperature sensor, and/or other sensors or combinations of sensors. In some implementations, the image capture device 200 may contain one or more other metadata/telemetry sources, e.g., image sensor parameters, battery monitor, storage parameters, and/or other information related to camera operation and/or capture of content. The metadata unit 232 may obtain information related to the environment of the image capture device 200 and aspects in which the content is captured.

For example, the metadata unit 232 may include an accelerometer that may provide device motion information including velocity and/or acceleration vectors representative of motion of the image capture device 200. In another example, the metadata unit 232 may include a gyroscope that may provide orientation information describing the orientation of the image capture device 200. In another example, the metadata unit 232 may include a GPS sensor that may provide GPS coordinates, time, and information identifying a location of the image capture device 200. In another example, the metadata unit 232 may include an altimeter that may obtain information indicating an altitude of the image capture device 200.

In some implementations, the metadata unit 232, or one or more portions thereof, may be rigidly coupled to the image capture device 200 such that motion, changes in orientation, or changes in the location of the image capture device 200 may be accurately detected by the metadata unit 232. Although shown as a single unit, the metadata unit 232, or one or more portions thereof, may be implemented as multiple distinct units. For example, the metadata unit 232 may include a temperature sensor as a first physical unit and a GPS unit as a second physical unit. In some implementations, the metadata unit 232, or one or more portions thereof, may be included in an image capture device 200 as shown, or may be included in a physically separate unit operatively coupled to, such as in communication with, the image capture device 200.

In some implementations, the optics unit 234 may include one or more of a lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optics component. In some implementations, the optics unit 234 may include a focus controller unit that may control the operation and configuration of the camera lens. The optics unit 234 may receive light from an object and may focus received light onto an image sensor 230. Although not shown separately in FIG. 2, in some implementations, the optics unit 234 and the image sensor 230 may be combined, such as in a combined physical unit, such as a housing.

In some implementations, the communication unit 240 may be coupled to the I/O unit 214 and may include a component (e.g., a dongle) having an infrared sensor, a radio frequency transceiver and antenna, an ultrasonic transducer, and/or other communications interfaces used to send and receive wireless communication signals. In some implementations, the communication unit 240 may include a local (e.g., Bluetooth, Wi-Fi) and/or broad range (e.g., cellular LTE) communications interface for communication between the image capture device 200 and a remote device (e.g., the user interface device 120 in FIG. 1). The communication unit 240 may communicate using, for example, Ethernet, 802.11, worldwide interoperability for microwave access (WiMAX), 3G, Long Term Evolution (LTE), digital subscriber line (DSL), asynchronous transfer mode (ATM), InfiniBand, PCI Express Advanced Switching, and/or other communication technologies. In some implementations, the communication unit 240 may communicate using networking protocols, such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or other networking protocols.

Information exchanged via the communication unit 240 may be represented using formats including one or more of hypertext markup language (HTML), extensible markup language (XML), and/or other formats. One or more exchanges of information between the image capture device 200 and remote or external devices may be encrypted using encryption technologies including one or more of secure sockets layer (SSL), transport layer security (TLS), virtual private networks (VPNs), Internet Protocol security (IPsec), and/or other encryption technologies.

In some implementations, the one or more power systems 250 supply power to the image capture device 200. For example, for a small-sized, lower-power action camera a wireless power solution (e.g., battery, solar cell, inductive (contactless) power source, rectification, and/or other power supply) may be used.

Consistent with the present disclosure, the components of the image capture device 200 may be remote from one another and/or aggregated. For example, one or more sensor components may be distal from the image capture device 200, e.g., such as shown and described with respect to FIG. 1. Multiple mechanical, sensory, or electrical units may be controlled by a learning apparatus via network/radio connectivity.

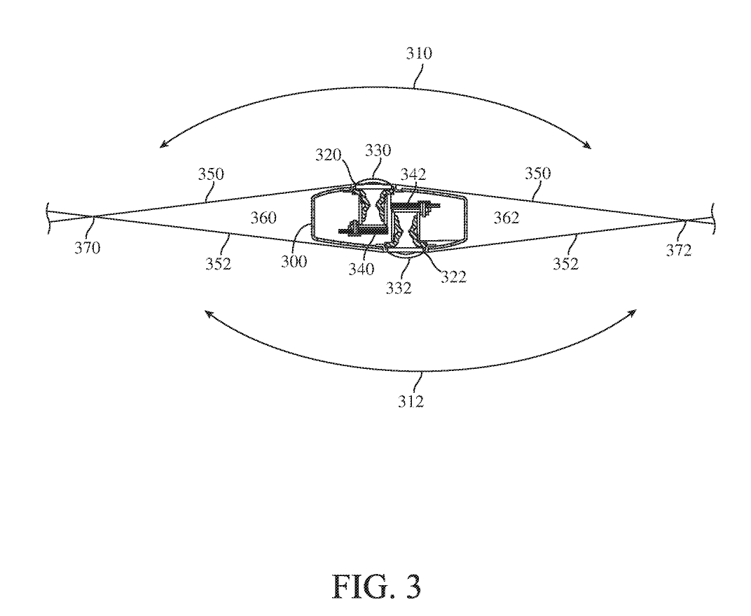

FIG. 3 is a cross-sectional view of an example of a dual-lens image capture apparatus 300 including overlapping fields-of-view 310, 312 in accordance with implementations of this disclosure. In some implementations, the image capture apparatus 300 may be a spherical image capture apparatus with fields-of-view 310, 312 as shown in FIG. 3. For example, the image capture apparatus 300 may include image capture devices 320, 322, related components, or a combination thereof, arranged in a back-to-back or Janus configuration. For example, a first image capture device 320 may include a first lens 330 and a first image sensor 340, and a second image capture device 322 may include a second lens 332 and a second image sensor 342 arranged oppositely from the first lens 330 and the first image sensor 340.

The first lens 330 of the image capture apparatus 300 may have the field-of-view 310 shown above a boundary 350. Behind the first lens 330, the first image sensor 340 may capture a first hyper-hemispherical image plane from light entering the first lens 330, corresponding to the first field-of-view 310.

The second lens 332 of the image capture apparatus 300 may have a field-of-view 312 as shown below a boundary 352. Behind the second lens 332, the second image sensor 342 may capture a second hyper-hemispherical image plane from light entering the second lens 332, corresponding to the second field-of-view 312.

In some implementations, one or more areas, such as blind spots 360, 362, may be outside of the fields-of-view 310, 312 of the lenses 330, 332, light may be obscured from the lenses 330, 332 and the corresponding image sensors 340, 342, and content in the blind spots 360, 362 may be omitted from capture. In some implementations, the image capture apparatus 300 may be configured to minimize the blind spots 360, 362.

In some implementations, the fields-of-view 310, 312 may overlap. Stitch points 370, 372, proximal to the image capture apparatus 300, at which the fields-of-view 310, 312 overlap may be referred to herein as overlap points or stitch points. Content captured by the respective lenses 330, 332, distal to the stitch points 370, 372, may overlap.

In some implementations, images contemporaneously captured by the respective image sensors 340, 342 may be combined to form a combined image. Combining the respective images may include correlating the overlapping regions captured by the respective image sensors 340, 342, aligning the captured fields-of-view 310, 312, and stitching the images together to form a cohesive combined image.

In some implementations, a small change in the alignment (e.g., position and/or tilt) of the lenses 330, 332, the image sensors 340, 342, or both may change the relative positions of their respective fields-of-view 310, 312 and the locations of the stitch points 370, 372. A change in alignment may affect the size of the blind spots 360, 362, which may include changing the size of the blind spots 360, 362 unequally.

In some implementations, incomplete or inaccurate information indicating the alignment of the image capture devices 320, 322, such as the locations of the stitch points 370, 372, may decrease the accuracy, efficiency, or both of generating a combined image. In some implementations, the image capture apparatus 300 may maintain information indicating the location and orientation of the lenses 330, 332 and the image sensors 340, 342 such that the fields-of-view 310, 312, stitch points 370, 372, or both may be accurately determined, which may improve the accuracy, efficiency, or both of generating a combined image.

In some implementations, optical axes through the lenses 330, 332 may be substantially antiparallel to each other, such that the respective axes may be within a tolerance such as 1%, 3%, 5%, 10%, and/or other tolerances. In some implementations, the image sensors 340, 342 may be substantially perpendicular to the optical axes through their respective lenses 330, 332, such that the image sensors may be perpendicular to the respective axes to within a tolerance such as 1%, 3%, 5%, 10%, and/or other tolerances.

In some implementations, the lenses 330, 332 may be laterally offset from each other, may be off-center from a central axis of the image capture apparatus 300, or may be laterally offset and off-center from the central axis. As compared to an image capture apparatus with back-to-back lenses (e.g., lenses aligned along the same axis), the image capture apparatus 300 including laterally offset lenses 330, 332 may include substantially reduced thickness relative to the lengths of the lens barrels securing the lenses 330, 332. For example, the overall thickness of the image capture apparatus 300 may be close to the length of a single lens barrel as opposed to twice the length of a single lens barrel as in a back-to-back configuration. Reducing the lateral distance between the lenses 330, 332 may improve the overlap in the fields-of-view 310, 312.

In some implementations, images or frames captured by an image capture apparatus, such as the image capture apparatus 110 shown in FIG. 1 or the image capture apparatus 300 shown in FIG. 3, may be combined, merged, or stitched together, to produce a combined image, such as a spherical or panoramic image, which may be an equirectangular planar image. In some implementations, generating a combined image may include three-dimensional, or spatiotemporal, noise reduction (3DNR). In some implementations, pixels along the stitch boundary may be matched accurately to minimize boundary discontinuities.

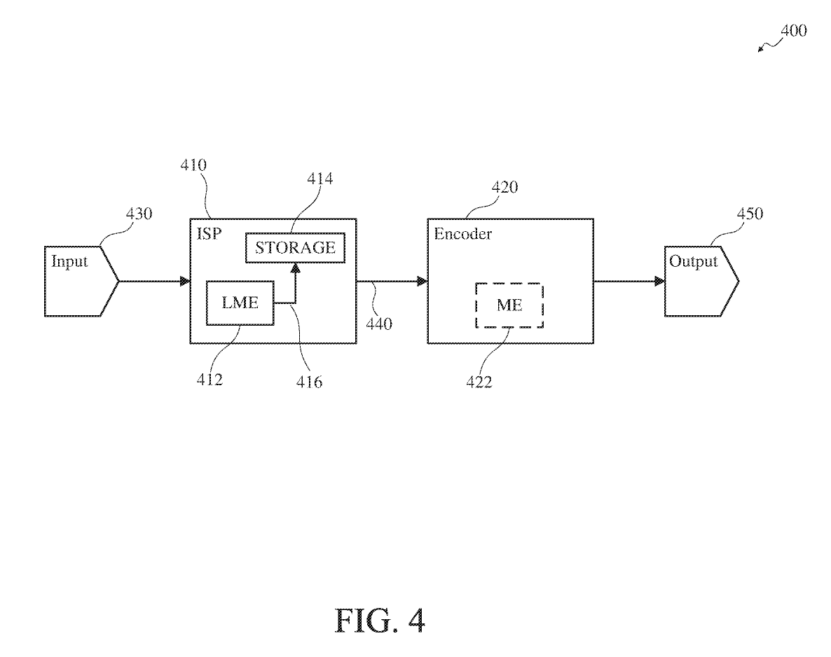

FIG. 4 is a block diagram of an example of an image processing and coding pipeline 400 in accordance with implementations of this disclosure. In some implementations, the image processing and coding pipeline 400 may be included in an image capture device, such as the image capture device 200 shown in FIG. 2, or an image capture apparatus, such as the image capture apparatus 110 shown in FIG. 1 or the image capture apparatus 300 shown in FIG. 3. In some implementations, the image processing and coding pipeline 400 may include an image signal processor (ISP) 410, an encoder 420, or a combination thereof.

In some implementations, the image signal processor 410 may receive an input image signal 430. For example, an image sensor (not shown), such as image sensor 230 shown in FIG. 2, may capture an image, or a portion thereof, and may send, or transmit, the captured image, or image portion, to the image signal processor 410 as the input image signal 430. In some implementations, an image, or frame, such as an image, or frame, included in the input image signal, may be one of a sequence or series of images or frames of a video, such as a sequence, or series, of frames captured at a rate, or frame rate, which may be a number or cardinality of frames captured per defined temporal period, such as 24, 30, or 60 frames per second.

In some implementations, the image signal processor 410 may include a local motion estimation (LME) unit 412, which may generate local motion estimation information for use in image signal processing and encoding, such as in correcting distortion, stitching, and/or motion compensation. In some implementations, the local motion estimation unit 412 may partition the input image signal 430 into blocks (e.g., having 4×4, 16×16, 64×64, and/or other dimensions). In some implementations, the local motion estimation unit 412 may partition the input image signal 430 into arbitrarily shaped patches and/or individual pixels.

In some implementations, the local motion estimation unit 412 may compare pixel values of blocks of pixels between image frames, such as successive image frames, from the input image signal 430 to determine displacement, or movement, between frames. The local motion estimation unit 412 may produce motion vectors (e.g., an x component and y component of motion) at multiple locations within an image frame. The motion vectors may be represented by a translational model or other models that may approximate camera motion, such as rotation and translation in three dimensions, and zooming.

In some implementations, the image signal processor 410 of the image processing and coding pipeline 400 may include electronic storage 414, such as memory (e.g., random access memory (RAM), flash, or other types of memory). The electronic storage 414 may store local motion estimation information 416 determined by the local motion estimation unit 412 for one or more frames. The local motion estimation information 416 and associated image or images may be output 440 to the encoder 420. In some implementations, the electronic storage 414 may include a buffer, or cache, and may buffer the input image signal as an input, or source, image, or frame.

In some implementations, the image signal processor 410 may output an image, associated local motion estimation information 416, or both as the output 440. For example, the image signal processor 410 may receive the input image signal 430, process the input image signal 430, and output a processed image as the output 440. Processing the input image signal 430 may include generating and using the local motion estimation information 416, spatiotemporal noise reduction (3DNR), dynamic range enhancement, local tone adjustment, exposure adjustment, contrast adjustment, image stitching, and/or other operations.

The encoder 420 may encode or compress the output 440 of the image signal processor 410. In some implementations, the encoder 420 may implement the one or more encoding standards, which may include motion estimation.

In some implementations, the encoder 420 may output encoded video as an encoded output 450. For example, the encoder 420 may receive the output 440 of the image signal processor 410, which may include processed images, the local motion estimation information 416, or both. The encoder 420 may encode the images and may output the encoded images as the encoded output 450.

In some implementations, the encoder 420 may include a motion estimation unit 422 that may determine motion information for encoding the image output 440 of the image signal processor 410. In some implementations, the encoder 420 may encode the image output 440 of the image signal processor 410 using motion information generated by the motion estimation unit 422 of the encoder 420, the local motion estimation information 416 generated by the local motion estimation unit 412 of the image signal processor 410, or a combination thereof. For example, the motion estimation unit 422 may determine motion information at pixel block sizes that may differ from pixel block sizes used by the local motion estimation unit 412. In another example, the motion estimation unit 422 of the encoder 420 may generate global motion information and the encoder may encode the image output 440 of the image signal processor 410 using the global motion information generated by the motion estimation unit 422 of the encoder 420 and the local motion estimation information 416 generated by the local motion estimation unit 412 of the image signal processor 410. In another example, the motion estimation unit 422 of the encoder 420 may use the local motion estimation information 416 generated by the local motion estimation unit 412 of the image signal processor 410 as input for efficiently and accurately generating motion information.

In some implementations, the image signal processor 410, the encoder 420, or both may be distinct units, as shown. For example, the image signal processor 410 may include a motion estimation unit, such as the local motion estimation unit 412 as shown, and/or the encoder 420 may include a motion estimation unit, such as the motion estimation unit 422.

In some implementations, the image signal processor 410 may store motion information, such as the local motion estimation information 416, in a memory, such as the electronic storage 414, and the encoder 420 may read the motion information from the electronic storage 414 or otherwise receive the motion information from the image signal processor 410. The encoder 420 may use the motion estimation information determined by the image signal processor 410 for motion compensation processing.

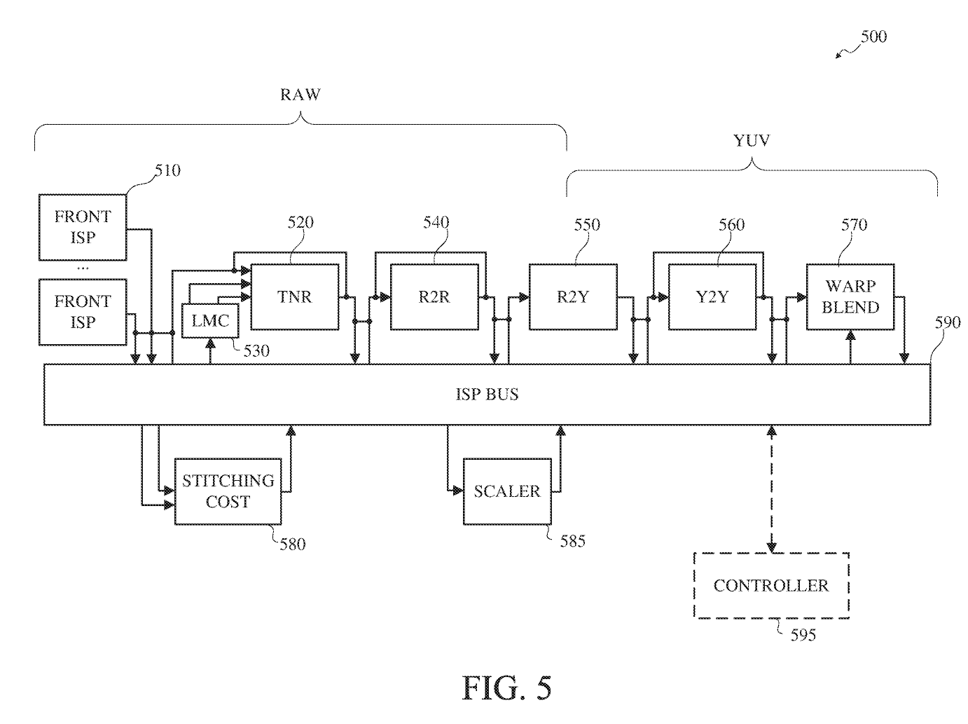

FIG. 5 is a functional block diagram of an example of an image signal processor 500 in accordance with implementations of this disclosure. In some implementations, an image signal processor 500 may be included in an image capture device, such as the image capture device 200 shown in FIG. 2, or an image capture apparatus, such as the image capture apparatus 110 shown in FIG. 1 or the image capture apparatus 300 shown in FIG. 3. In some implementations, the image signal processor 500 may be similar to the image signal processor 410 shown in FIG. 4.

In some implementations, the image signal processor 500 may receive an image signal, such as from an image sensor, in a defined format, such as a format of the image sensor, which may be referred to herein as “a raw image”, “raw image data”, “raw data”, “a raw signal”, or “a raw image signal.” For example, the raw image signal may be in a format such as RGB format, which may represent individual pixels using a combination of values or components, such as a red component (R), a green component (G), and a blue component (B). In some implementations, the image signal processor 500 may convert the raw image data (RGB data) to another format, such as a format expressing individual pixels using a combination of values or components, such as a luminance, or luma, value (Y), a blue chrominance, or chroma, value (U or Cb), and a red chroma value (V or Cr), such as the YUV or YCbCr formats.

In some implementations, the image signal processor 500 may include a front image signal processor (Front ISP) 510, or multiple front image signal processors as shown, a temporal noise reduction (TNR) unit 520, a local motion compensation unit 530, a raw to raw (R2R) unit 540, a raw to YUV (R2Y) unit 550, a YUV to YUV (Y2Y) unit 560, a combined warp and blend unit 570, a stitching cost unit 580, a scaler 585, an image signal processing bus (ISP BUS) 590, or a combination thereof.

Although not shown expressly in FIG. 5, in some implementations, one or more of the front image signal processor 510, the temporal noise reduction unit 520, the local motion compensation unit 530, the raw to raw unit 540, the raw to YUV unit 550, the YUV to YUV unit 560, the combined warp and blend unit 570, the stitching cost unit 580, the scaler 585, the image signal processing bus 590, or any combination thereof, may include a respective clock, power domain, or both.

In some implementations, the front image signal processor 510 may minimally process image signals received from respective image sensors, which may include image scaling. Scaling, by the front image signal processor 510, may include processing pixels, such as a defined cardinality of pixels, corresponding to a determined quality. For example, the front image signal processor 510 may correct dead pixels, perform band processing, decouple vertical blanking, or a combination thereof. In some implementations, the front image signal processor 510 may output a full resolution frame, a low resolution frame, such as a ¼×¼ resolution frame, or both.

In some implementations, a multiple camera apparatus, such as the image capture apparatus 110 shown in FIG. 1, may include multiple image capture devices, such as the image capture device 200 shown in FIG. 2, and may include a respective front image signal processor 510 associated with each image capture device.

In some implementations, the temporal noise reduction unit 520 may reduce temporal noise in input images, which may include recursively reducing temporal noise in a sequence of input images, such as a video. Recursive temporal noise reduction may include combining a current image with noise feedback information corresponding to a previously processed frame (recirculated frame). The recirculated frame may be local motion compensated and may be received from the local motion compensation unit 530. The temporal noise reduction unit 520 may generate output including a pixel value and associated noise variance for the pixel value for one or more pixels of the current frame.

In some implementations, the local motion compensation unit 530 may determine motion vectors for the input image and/or video data for representing motion in an image frame, such as motion caused by moving objects in the field-of-view. In some implementations, the local motion compensation unit 530 may apply motion vectors to align a recirculated frame from the temporal noise reduction unit 520 with the incoming, current frame.

In some implementations, the temporal noise reduction unit 520 may reduce temporal noise using three-dimensional (3D) noise reduction (3DNR), such as in conjunction with the local motion compensation unit 530.

In some implementations, the raw to raw unit 540 may perform spatial denoising of frames of raw images based on noise variance values received from the temporal noise reduction unit 520. For example, spatial denoising in the raw to raw unit 540 may include multiple passes of image signal processing, including passes at various resolutions.

In some implementations, the raw to YUV unit 550 may demosaic, and/or color process, the frames of raw images, which may include representing each pixel in the YUV format, which may include a combination of a luminance (Y) component and two chrominance (UV) components.

In some implementations, the YUV to YUV unit 560 may perform local tone mapping of YUV images. In some implementations, the YUV to YUV unit 560 may include multi-scale local tone mapping using a multi-pass approach on a frame at different scales.

In some implementations, the warp and blend unit 570 may warp images, blend images, or both. In some implementations, the warp and blend unit 570 may warp a corona around the equator of each frame to a rectangle. For example, the warp and blend unit 570 may warp a corona around the equator of each frame to a rectangle based on the corresponding low resolution frame generated by the front image signal processor 510.

In some implementations, the warp and blend unit 570 may apply one or more transformations to the frames. In some implementations, spherical images produced by a multi-face camera device, such as the image capture apparatus 110 shown in FIG. 1 or the image capture apparatus 300 shown in FIG. 3, may be warped and/or blended by the warp and blend unit 570 to correct for distortions at image edges. In some implementations, the warp and blend unit 570 may apply a transformation that is subject to a close to identity constraint, wherein a location of a pixel in an input image to the warp and blend unit 570 may be similar to, such as within a defined distance threshold of, a location of a corresponding pixel in an output image from the warp and blend unit 570. For example, the warp and blend unit 570 may include an internal memory, which may have a size, such as 100 lines, which may be smaller than a size of a frame, and the warp and blend unit 570 may process the input image data in raster-in/raster-out order using a transformation that is subject to a close to identity constraint. In some implementations, the warp and blend unit 570 may apply a transformation that is independent of close to identity constraints, which may include processing the input image data in raster-in/dynamic-out or dynamic-in/raster-out order. For example, the warp and blend unit 570 may transform two or more non-rectilinear (fisheye) images to generate a combined frame, such as an equirectangular frame, by processing the input image data in raster-in/dynamic-out or dynamic-in/raster-out order.

In some implementations, the stitching cost unit 580 may generate a stitching cost map as an output. In some implementations, the cost map may be represented as a rectangle having disparity x and longitude y based on a warping. Each value of the cost map may be a cost function of a disparity x value for a corresponding longitude. Cost maps may be generated for various scales, longitudes, and disparities.

In some implementations, the scaler 585 may scale images received from the output of the warp and blend unit 570, which may be in patches, or blocks, of pixels such as 16×16 blocks, 8×8 blocks, or patches or blocks of any other size or combination of sizes.

In some implementations, the image signal processing bus 590 may be a bus or interconnect, such as an on-chip interconnect or embedded microcontroller bus interface, for communication between the front image signal processor 510, the temporal noise reduction unit 520, the local motion compensation unit 530, the raw to raw unit 540, the raw to YUV unit 550, the YUV to YUV unit 560, the combined warp and blend unit 570, the stitching cost unit 580, the scaler 585, the configuration controller 595, or any combination thereof.

In some implementations, a configuration controller 595 may coordinate image processing by the front image signal processor 510, the temporal noise reduction unit 520, the local motion compensation unit 530, the raw to raw unit 540, the raw to YUV unit 550, the YUV to YUV unit 560, the combined warp and blend unit 570, the stitching cost unit 580, the scaler 585, or any combination thereof, of the image signal processor 500. For example, the configuration controller 595 may control camera alignment model calibration, auto-exposure, auto-white balance, or any other camera calibration or similar process or combination of processes. In some implementations, the configuration controller 595 may be a microcontroller. The configuration controller 595 is shown in FIG. 5 using broken lines to indicate that the configuration controller 595 may be included in the image signal processor 500 or may be external to, and in communication with, the image signal processor 500. The configuration controller 595 may include a respective clock, power domain, or both.

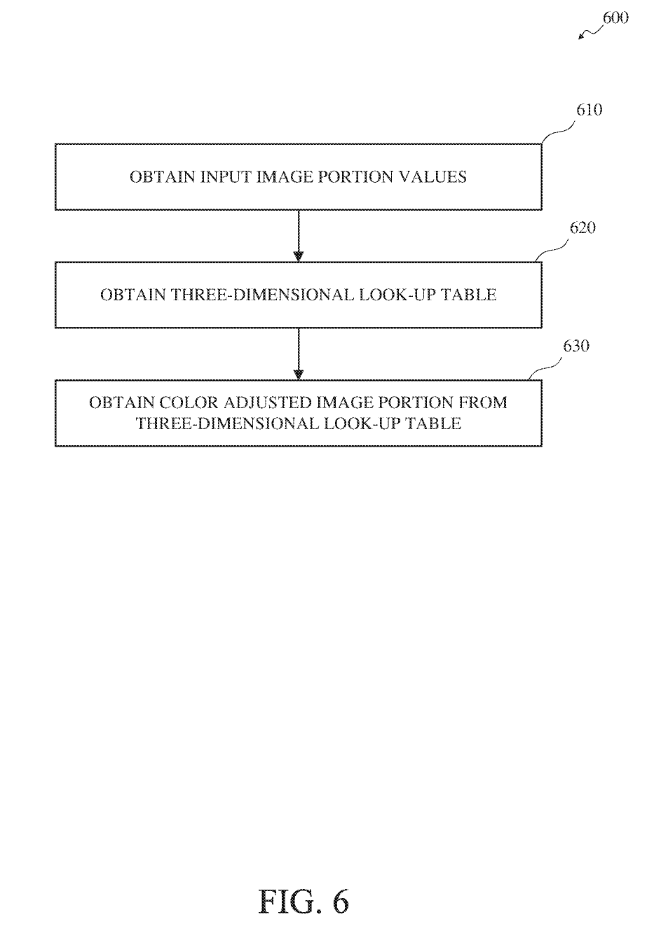

FIG. 6 is a diagram of an example of obtaining a color adjusted image portion using a three-dimensional look-up table in accordance with implementations of this disclosure. In some implementations, obtaining a color adjusted image portion using a three-dimensional look-up table 600 may be implemented in an image capture apparatus, such as the image capture apparatus 110 shown in FIG. 1 or the image capture apparatus 300 shown in FIG. 3. For example, the image signal processor 500 shown in FIG. 5 may implement obtaining a color adjusted image portion using a three-dimensional look-up table 600. In some implementations, obtaining a color adjusted image portion using a three-dimensional look-up table 600 may include obtaining input image portion values at 610, obtaining a three-dimensional look-up table at 620, and obtaining color adjusted image portion values from the three-dimensional look-up table at 630. For example, a frame, picture, or image, may include multiple pixels, each pixel having respective input values, and obtaining a color adjusted image portion using a three-dimensional look-up table 600 may be performed for one or more, such as each, of the input pixels to obtain respective color adjusted values.

Although not shown separately in FIG. 6, an image signal processor, such as the image signal processor 410 shown in FIG. 4 or the image signal processor 500 shown in FIG. 5, which may be included in an image capture apparatus, may receive one or more input image signals, such as the input image signal 430 shown in FIG. 4, from one or more image sensors, such as the image sensor 230 shown in FIG. 2 or the image sensors 340, 342 shown in FIG. 3, or from one or more front image signal processors, such as the front image signal processors 510 shown in FIG. 5, and may identify one or more input images, or frames, from the one or more input image signals, which may include buffering the input images or frames.

Although not shown separately in FIG. 6, obtaining a color adjusted image portion using a three-dimensional look-up table 600 may include determining whether to obtain a color adjusted image portion.

Input image portion values may be obtained at 610. Obtaining input image portion values may include obtaining, such as by reading from memory, one or more values, such as a color value, a luminance value, a chrominance value, or a combination thereof, of one or more input image portions, such as for a pixel or a block of pixels of an input image or frame. For example, the input image portion may be a pixel and the input image portion values may include color values, such as a red color value (R), a green color value (G), and a blue color value (B).

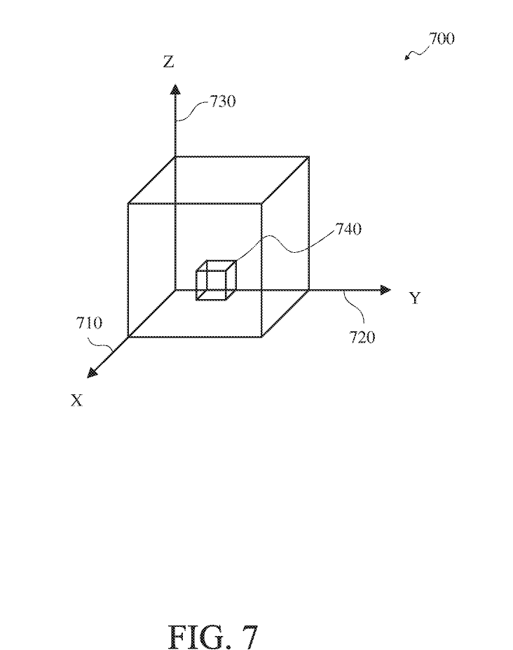

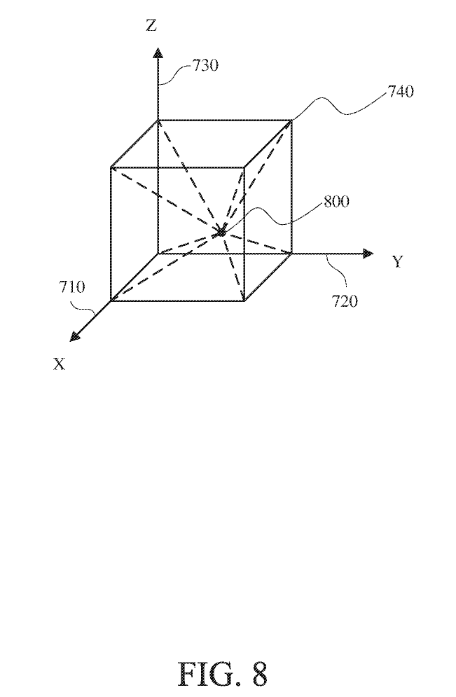

A three-dimensional look-up table may be obtained at 620. Obtaining a three-dimensional look-up table may include reading the three-dimensional look-up table, or a portion thereof, from memory. An example of a three-dimensional look-up table is shown in FIGS. 7 and 8.

Color adjusted image portion values may be obtained from the three-dimensional look-up table at 630. Obtaining the color adjusted image portion values may include interpolating one or more color values, such as using trilinear interpolation. For example, color adjusted image portion values (RGB′) may be obtained from the three-dimensional look-up table based on a function (ƒ) of the respective input values (R, G, and B), which may be expressed as RGB′=ƒ(R, G, B). For example, the three-dimensional (RGB) look-up table may include four thousand values for R, four thousand values for G, and four thousand values for B, and may include twelve thousand RGB values.

FIG. 7 is a diagram of an example of a representation of a three-dimensional look-up table 700 in accordance with implementations of this disclosure. A three-dimensional look-up table 700 may represent image processing information, such as a color space, which may be an RGB color space, using three dimensions or axis, which may be mutually orthogonal, such as a first axis (X) 710 representing a first color component, such as the red color component (R), a second axis (Y) 720 representing a second color component, such as the green color component (G), and a third axis (Z) 730 representing a third color component, such as the blue color component (B). In some embodiments, a three-dimensional look-up table may be segmented into three-dimensional portions (cubes) 740, such as 16×16×16 size cubes. An example of the cube 740 is shown in FIG. 8.

FIG. 8 is a diagram of an example of a representation of a portion (cube) 740 of a three-dimensional look-up table in accordance with implementations of this disclosure. A three-dimensional look-up table, such as the three-dimensional look-up table 700 shown in FIG. 7, may represent image processing information, such as a color space, which may be an RGB color space, using three mutually orthogonal dimensions or axes, such as a first axis (X) 710 representing a first color component, such as the red color component (R), a second axis (Y) 720 representing a second color component, such as the green color component (G), and a third axis (Z) 730 representing a third color component, such as the blue color component (B), which may be segmented into three-dimensional portions (cubes) 740, such as N×N×N size cubes. For example, a 16×16×16 size cube may include 4096 values.

A color, such as the color of a pixel, may be represented in a three-dimensional (RGB) look-up table as the intersection 800 of a respective value for each of the three color components. In some embodiments, color adjusted image portion values may be obtained from the three-dimensional look-up table based on input color values, which may include interpolating one or more color values, such as using trilinear interpolation. For example, color adjusted image portion values (RGB′) may be obtained from the three-dimensional look-up table based on a function (ƒ) of the respective input values (R, G, and B), which may be expressed as RGB′=ƒ(R, G, B). For example, the three-dimensional (RGB) look-up table may include four thousand values for R, four thousand values for G, and four thousand values for B, and may include twelve thousand RGB values.

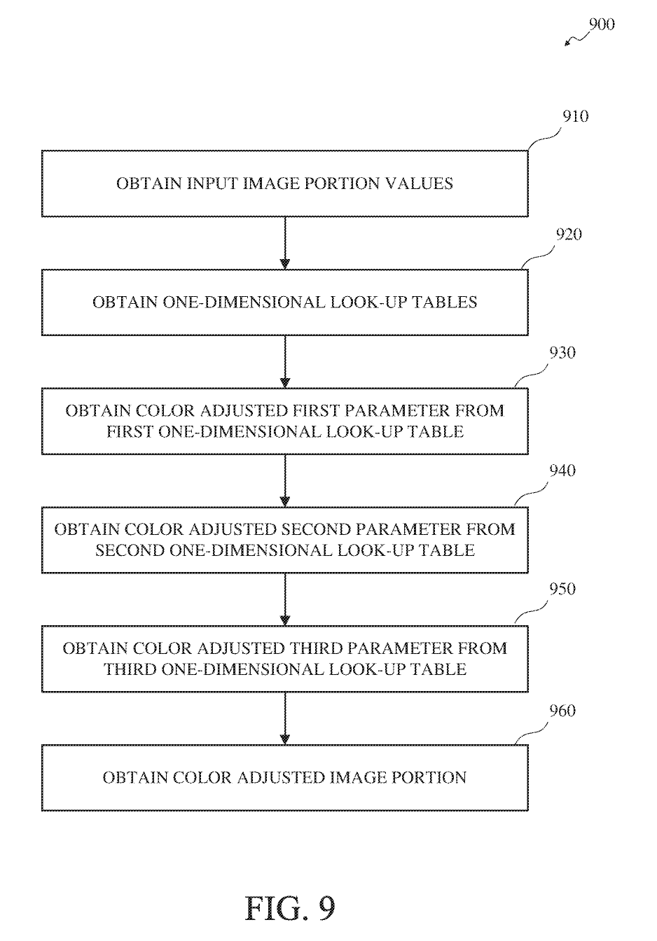

FIG. 9 is a diagram of an example of obtaining a color adjusted image portion using sub-three-dimensional look-up tables in accordance with implementations of this disclosure. In some implementations, obtaining a color adjusted image portion using sub-three-dimensional look-up tables 900 may be implemented in an image capture apparatus, such as the image capture apparatus 110 shown in FIG. 1 or the image capture apparatus 300 shown in FIG. 3. For example, the image signal processor 500 shown in FIG. 5 may implement obtaining a color adjusted image portion using sub-three-dimensional look-up tables 900. In some implementations, obtaining a color adjusted image portion using sub-three-dimensional look-up tables 900 may include obtaining input image portion values at 910, obtaining one-dimensional look-up tables at 920, obtaining a color adjusted first parameter at 930, obtaining a color adjusted second parameter at 940, obtaining a color adjusted third parameter at 950, obtaining a color adjusted image portion at 960, or a combination thereof. For example, a frame, picture, or image, may include multiple pixels, each pixel having respective input values, and obtaining a color adjusted image portion using sub-three-dimensional look-up tables 900 may be performed for one or more, such as each, of the input pixels to obtain respective color adjusted values.

Although not shown separately in FIG. 9, an image signal processor, such as the image signal processor 410 shown in FIG. 4 or the image signal processor 500 shown in FIG. 5, which may be included in an image capture apparatus, may receive one or more input image signals, such as the input image signal 430 shown in FIG. 4, from one or more image sensors, such as the image sensor 230 shown in FIG. 2 or the image sensors 340, 342 shown in FIG. 3, or from one or more front image signal processors, such as the front image signal processors 510 shown in FIG. 5, and may identify one or more input images, or frames, from the one or more input image signals, which may include buffering the input images or frames.

Although not shown separately in FIG. 9, obtaining a color adjusted image portion using sub-three-dimensional look-up tables 900 may include determining whether to obtain a color adjusted image portion.

Input image portion values may be obtained at 910. Obtaining input image portion values may include obtaining, such as by reading from memory, one or more values, such as a color value, a luminance value, a chrominance value, or a combination thereof, of one or more input image portions, such as for a pixel or a block of pixels of an input image or frame. For example, the input image portion may be a pixel and the input image portion values may include color values, such as a red color value (R), a green color value (G), and a blue color value (B).

One-dimensional look-up tables may be obtained at 920. Obtaining one-dimensional look-up tables may include obtaining one or more one-dimensional look-up tables corresponding to each color component, such as M×M one-dimensional look-up tables for image portions having M components, which may be nine (3×3=9) one-dimensional look-up tables for image portions having three (M=3) components, such as RGB components. Each one-dimensional look-up table may include N values, such as 16 values. Obtaining the one-dimensional look-up tables may include obtaining a respective one-dimensional look-up table for each color component as a function of each binary combination of color components. In some embodiments, a one-dimensional look-up table may be a sub-sampled interpolated look-up table.

For example, obtaining the one-dimensional look-up tables may include obtaining a one-dimensional look-up table for the red (R) color component as a function of the red (R) color component, which may be expressed as ƒ_{RR}(R); obtaining a one-dimensional look-up table for the red (R) color component as a function of the green (G) color component, which may be expressed as ƒ_{RG}(G); obtaining a one-dimensional look-up table for the red (R) color component as a function of the blue (B) color component, which may be expressed as ƒ_{RB}(B); obtaining a one-dimensional look-up table for the green (G) color component as a function of the red (R) color component, which may be expressed as ƒ_{GR}(R); obtaining a one-dimensional look-up table for the green (G) color component as a function of the green (G) color component, which may be expressed as ƒ_{GG}(G); obtaining a one-dimensional look-up table for the green (G) color component as a function of the blue (B) color component, which may be expressed as ƒ_{GB}(B); obtaining a one-dimensional look-up table for the blue (B) color component as a function of the red (R) color component, which may be expressed as ƒ_{BR}(R); obtaining a one-dimensional look-up table for the blue (B) color component as a function of the green (G) color component, which may be expressed as ƒ_{BG}(G); obtaining a one-dimensional look-up table for the blue (B) color component as a function of the blue (B) color component, which may be expressed as ƒ_{BB}(B); or a combination thereof.

A color adjusted first parameter may be obtained at 930. Obtaining the color adjusted first parameter (R′) may include obtaining a first component of the color adjusted first parameter from a one-dimensional look-up table based on the first parameter. For example, the first parameter may be the red (R) color component input value, the one-dimensional look-up table may be the one-dimensional look-up table for the red (R) color component as a function of the red (R) color component, which may be expressed as ƒ_{RR}(R), and obtaining the first component of the color adjusted first parameter (R′) from the one-dimensional look-up table ƒ_{RR}(R) based on the first parameter (R) may include obtaining the output of ƒ_{RR}(R).

Obtaining the color adjusted first parameter (R′) may include obtaining a second component of the color adjusted first parameter (R′) from a one-dimensional look-up table based on the second parameter. For example, the second parameter may be the green (G) color component input value, the one-dimensional look-up table may be the one-dimensional look-up table for the red (R) color component as a function of the green (G) color component, which may be expressed as ƒ_{RG}(G), and obtaining the second component of the color adjusted first parameter (R′) from the one-dimensional look-up table ƒ_{RG}(G) based on the second parameter (G) may include obtaining the output of ƒ_{RG}(G).

Obtaining the color adjusted first parameter (R′) may include obtaining a third component of the color adjusted first parameter (R′) from a one-dimensional look-up table based on the third parameter. For example, the third parameter may be the blue (B) color component input value, the one-dimensional look-up table may be the one-dimensional look-up table for the red (R) color component as a function of the blue (B) color component, which may be expressed as ƒ_{RB}(B), and obtaining the third component of the color adjusted first parameter (R′) from the one-dimensional look-up table ƒ_{RB}(B) based on the third parameter (B) may include obtaining the output of ƒ_{RB}(B).

Obtaining the color adjusted first parameter (R′) may include obtaining a sum, or other mathematical combination, of the first component (ƒ_{RR}(R)) of the color adjusted first parameter (R′), the second component (ƒ_{RG}(G)) of the color adjusted first parameter (R′), and the third component (ƒ_{RB}(B)) of the color adjusted first parameter (R′), which may be expressed as R′=ƒ_{RR}(R)+ƒ_{RG}(G)+ƒ_{RB}(B).

A color adjusted second parameter (G′) may be obtained at 940. Obtaining the color adjusted second parameter (G′) may include obtaining a first component of the color adjusted second parameter (G′) from a one-dimensional look-up table based on the first parameter. For example, the first parameter may be the red (R) color component input value, the one-dimensional look-up table may be the one-dimensional look-up table for the green (G) color component as a function of the red (R) color component, which may be expressed as ƒ_{GR}(R), and obtaining the first component of the color adjusted second parameter (G′) from the one-dimensional look-up table ƒ_{GR}(R) based on the first parameter (R) may include obtaining the output of ƒ_{GR}(R).

Obtaining the color adjusted second parameter (G′) may include obtaining a second component of the color adjusted second parameter (G′) from a one-dimensional look-up table based on the second parameter. For example, the second parameter may be the green (G) color component input value, the one-dimensional look-up table may be the one-dimensional look-up table for the green (G) color component as a function of the green (G) color component, which may be expressed as ƒ_{GG}(G), and obtaining the second component of the color adjusted second parameter (G′) from the one-dimensional look-up table ƒ_{GG}(G) based on the second parameter (G) may include obtaining the output of ƒ_{GG}(G).

Obtaining the color adjusted second parameter (G′) may include obtaining a third component of the color adjusted second parameter (G′) from a one-dimensional look-up table based on the third parameter. For example, the third parameter may be the blue (B) color component input value, the one-dimensional look-up table may be the one-dimensional look-up table for the green (G) color component as a function of the blue (B) color component, which may be expressed as ƒ_{GB}(B), and obtaining the third component of the color adjusted second parameter (G′) from the one-dimensional look-up table ƒ_{GB}(B) based on the third parameter (B) may include obtaining the output of ƒ_{GB}(B).

Obtaining the color adjusted second parameter (G′) may include obtaining a sum, or other mathematical combination, of the first component (ƒ_{GR}(R)) of the color adjusted second parameter (G′), the second component (ƒ_{GG}(G)) of the color adjusted second parameter (G′), and the third component (ƒ_{GB} (B)) of the color adjusted second parameter (G′), which may be expressed as G′=ƒ_{GR}(R)+ƒ_{GG}(G)+ƒ_{GB}(B).

A color adjusted third parameter (B′) may be obtained at 950. Obtaining the color adjusted third parameter (B′) may include obtaining a first component of the color adjusted third parameter (B′) from a one-dimensional look-up table based on the first parameter. For example, the first parameter may be the red (R) color component input value, the one-dimensional look-up table may be the one-dimensional look-up table for the blue (B) color component as a function of the red (R) color component, which may be expressed as ƒ_{BR}(R), and obtaining the first component of the color adjusted third parameter (B′) from the one-dimensional look-up table ƒ_{BR}(R) based on the first parameter (R) may include obtaining the output of ƒ_{BR}(R).

Obtaining the color adjusted third parameter (B′) may include obtaining a second component of the color adjusted third parameter (B′) from a one-dimensional look-up table based on the second parameter. For example, the second parameter may be the green (G) color component input value, the one-dimensional look-up table may be the one-dimensional look-up table for the blue (B) color component as a function of the green (G) color component, which may be expressed as ƒ_{BG}(G), and obtaining the second component of the color adjusted third parameter (B′) from the one-dimensional look-up table ƒ_{BG}(G) based on the second parameter (G) may include obtaining the output of ƒ_{BG}(G).

Obtaining the color adjusted third parameter (B′) may include obtaining a third component of the color adjusted third parameter (B′) from a one-dimensional look-up table based on the third parameter. For example, the third parameter may be the blue (B) color component input value, the one-dimensional look-up table may be the one-dimensional look-up table for the blue (B) color component as a function of the blue (B) color component, which may be expressed as ƒ_{BB}(B), and obtaining the third component of the color adjusted third parameter (B′) from the one-dimensional look-up table ƒ_{BB}(B) based on the third parameter (B) may include obtaining the output of ƒ_{BB}(B).

Obtaining the color adjusted third parameter (B′) may include obtaining a sum, or other mathematical combination, of the first component (ƒ_{BR}(R)) of the color adjusted third parameter (B′), the second component (ƒ_{BG}(G)) of the color adjusted third parameter (B′), and the third component (ƒ_{BB}(B)) of the color adjusted third parameter (B′), which may be expressed as B′=ƒ_{BR}(R)+ƒ_{BG}(G)+ƒ_{BB}(B).

A color adjusted image portion may be obtained at 960. For example, the color adjusted image portion may be a combination of the color adjusted first parameter (R′) obtained at 930, the color adjusted second parameter (G′) obtained at 940, and the color adjusted third parameter (B′) obtained at 950. Although not shown separately in FIG. 9, the color adjusted image portion may be included in a color adjusted image, and the color adjusted image, or the color adjusted image portion, may be transmitted or stored, such as in a memory.

Where certain elements of these implementations may be partially or fully implemented using known components, those portions of such known components that are necessary for an understanding of the present disclosure have been described, and detailed descriptions of other portions of such known components have been omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote any type of interconnection or communication architecture that may be used to communicate data between two or more entities. The “bus” could be optical, wireless, infrared or another type of communication medium. The exact topology of the bus could be, for example, standard “bus,” hierarchical bus, network-on-chip, address-event-representation (AER) connection, or other type of communication topology used for accessing, e.g., different memories in a system.

As used herein, the terms “computer,” “computing device,” and “computerized device” include, but are not limited to, personal computers (PCs) and minicomputers (whether desktop, laptop, or otherwise), mainframe computers, workstations, servers, personal digital assistants (PDAs), handheld computers, embedded computers, programmable logic devices, personal communicators, tablet computers, portable navigation aids, Java 2 Platform, Micro Edition (J2ME) equipped devices, cellular telephones, smart phones, personal integrated communication or entertainment devices, or literally any other device capable of executing a set of instructions.

As used herein, the term “computer program” or “software” is meant to include any sequence of human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, Standard Generalized Markup Language (SGML), XML, Voice Markup Language (VoxML)), as well as object-oriented environments such as the Common Object Request Broker Architecture (CORBA), Java™ (including J2ME, Java Beans), and/or Binary Runtime Environment (e.g., Binary Runtime Environment for Wireless (BREW)).

As used herein, the terms “connection,” “link,” “transmission channel,” “delay line,” and “wireless” mean a causal link between any two or more entities (whether physical or logical/virtual) which enables information exchange between the entities.

As used herein, the terms “integrated circuit,” “chip,” and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data, including, without limitation, read-only memory (ROM), programmable ROM (PROM), electrically erasable PROM (EEPROM), dynamic random access memory (DRAM), Mobile DRAM, synchronous DRAM (SDRAM), Double Data Rate 2 (DDR/2) SDRAM, extended data out (EDO)/fast page mode (FPM), reduced latency DRAM (RLDRAM), static RAM (SRAM), “flash” memory (e.g., NAND/NOR), memristor memory, and pseudo SRAM (PSRAM).

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose complex instruction set computing (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW110, and/or other variations), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or out-of-band, cable modem, and/or other radio frequency tuner protocol interfaces), Wi-Fi (802.11), WiMAX (802.16), personal area network (PAN) (e.g., 802.15), cellular (e.g., 3G, LTE/LTE-A/TD-LTE, GSM, and/or other cellular technology), IrDA families, and/or other network interfaces.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), High Speed Downlink Packet Access/High Speed Uplink Packet Access (HSDPA/HSUPA), Time Division Multiple Access (TDMA), Code Division Multiple Access (CDMA)(e.g., IS-95A, Wideband CDMA (WCDMA), and/or other wireless technology), Frequency Hopping Spread Spectrum (FHSS), Direct Sequence Spread Spectrum (DSSS), Global System for Mobile communications (GSM), PAN/802.15, WiMAX (802.16), 802.20, narrowband/Frequency Division Multiple Access (FDMA), Orthogonal Frequency Division Multiplex (OFDM), Personal Communication Service (PCS)/Digital Cellular System (DCS), LTE/LTE-Advanced (LTE-A)/Time Division LTE (TD-LTE), analog cellular, cellular Digital Packet Data (CDPD), satellite systems, millimeter wave or microwave systems, acoustic, infrared (i.e., IrDA), and/or other wireless interfaces.

As used herein, the term “robot” may be used to describe an autonomous device, autonomous vehicle, computer, artificial intelligence (AI) agent, surveillance system or device, control system or device, and/or other computerized device capable of autonomous operation.

As used herein, the terms “camera,” or variations thereof, and “image capture device,” or variations thereof, may be used to refer to any imaging device or sensor configured to capture, record, and/or convey still and/or video imagery which may be sensitive to visible parts of the electromagnetic spectrum, invisible parts of the electromagnetic spectrum (e.g., infrared, ultraviolet), and/or other energy (e.g., pressure waves).

While certain aspects of the technology are described in terms of a specific sequence of steps of a method, these descriptions are illustrative of the broader methods of the disclosure and may be modified by the particular application. Certain steps may be rendered unnecessary or optional under certain circumstances. Additionally, certain steps or functionality may be added to the disclosed implementations, or the order of performance of two or more steps may be permuted. All such variations are considered to be encompassed within the disclosure.

While the above-detailed description has shown, described, and pointed out novel features of the disclosure as applied to various implementations, it will be understood that various omissions, substitutions, and changes in the form and details of the devices or processes illustrated may be made by those skilled in the art without departing from the disclosure. The foregoing description is in no way meant to be limiting, but rather should be taken as illustrative of the general principles of the technology.

What is claimed is:

1. A non-transitory computer-readable storage medium, comprising executable instructions that, when executed by a processor, facilitate performance of operations, comprising:
receiving an input image;
obtaining an input image portion from the input image;
obtaining a color adjusted image portion based on the input image portion by:
obtaining a value for the input image portion wherein the value is expressed as a combination of at least a first parameter, a second parameter, and a third parameter;
obtaining a color adjusted first parameter from at least a first one-dimensional look-up table based on the first parameter, the second parameter, and the third parameter;
obtaining a color adjusted second parameter from at least a second one-dimensional look-up table based on the first parameter, the second parameter, and the third parameter;
obtaining a color adjusted third parameter from at least a third one-dimensional look-up table based on the first parameter, the second parameter, and the third parameter; and
outputting the color adjusted image portion based on a combination of the color adjusted first parameter, the color adjusted second parameter, and the color adjusted third parameter;
including the color adjusted image portion in a color adjusted image; and
transmitting or storing the color adjusted image.

2. The non-transitory computer-readable storage medium of claim 1, wherein the first parameter represents a first color component, the second parameter represents a second color component, and the third parameter represents a third color component.

3. The non-transitory computer-readable storage medium of claim 2, wherein the first color component is a red color component, the second color component is a green color component, and the third color component is a blue color component.

4. The non-transitory computer-readable storage medium of claim 1, wherein obtaining the color adjusted first parameter includes obtaining the color adjusted first parameter from the first one-dimensional look-up table, a fourth one-dimensional look-up table, and a fifth one-dimensional look-up table.

5. The non-transitory computer-readable storage medium of claim 4, wherein obtaining the color adjusted first parameter includes:
obtaining a first component of the color adjusted first parameter from the first one-dimensional look-up table based on the first parameter;
obtaining a second component of the color adjusted first parameter from the fourth one-dimensional look-up table based on the second parameter;
obtaining a third component of the color adjusted first parameter from the fifth one-dimensional look-up table based on the third parameter; and
obtaining a sum of the first component of the color adjusted first parameter, the second component of the color adjusted first parameter, and the third component of the color adjusted first parameter as the color adjusted first parameter.

6. The non-transitory computer-readable storage medium of claim 1, wherein obtaining the color adjusted second parameter includes obtaining the color adjusted second parameter from the second one-dimensional look-up table, a sixth one-dimensional look-up table, and a seventh one-dimensional look-up table.

7. The non-transitory computer-readable storage medium of claim 6, wherein obtaining the color adjusted second parameter includes:
obtaining a first component of the color adjusted second parameter from the second one-dimensional look-up table based on the first parameter;
obtaining a second component of the color adjusted second parameter from the sixth one-dimensional look-up table based on the second parameter;
obtaining a third component of the color adjusted second parameter from the seventh one-dimensional look-up table based on the third parameter; and
obtaining a sum of the first component of the color adjusted second parameter, the second component of the color adjusted second parameter, and the third component of the color adjusted second parameter as the color adjusted second parameter.

8. The non-transitory computer-readable storage medium of claim 1, wherein obtaining the color adjusted third parameter includes obtaining the color adjusted third parameter from the third one-dimensional look-up table, an eighth one-dimensional look-up table, and a ninth one-dimensional look-up table.

9. The non-transitory computer-readable storage medium of claim 8, wherein obtaining the color adjusted third parameter includes:
obtaining a first component of the color adjusted third parameter from the third one-dimensional look-up table based on the first parameter;
obtaining a second component of the color adjusted third parameter from the eighth one-dimensional look-up table based on the second parameter;
obtaining a third component of the color adjusted third parameter from the ninth one-dimensional look-up table based on the third parameter; and
obtaining a sum of the first component of the color adjusted third parameter, the second component of the color adjusted third parameter, and the third component of the color adjusted third parameter as the color adjusted third parameter.

10. An image capture apparatus comprising:
an image signal processor configured to:
receive an input image;
obtain an input image portion from the input image;
obtain a value for the input image portion wherein the value is expressed as a combination of at least a first parameter, a second parameter, and a third parameter;
obtain a color adjusted first parameter from at least a first one-dimensional look-up table based on the first parameter, the second parameter, and the third parameter;
obtain a color adjusted second parameter from at least a second one-dimensional look-up table based on the first parameter, the second parameter, and the third parameter;
obtain a color adjusted third parameter from at least a third one-dimensional look-up table based on the first parameter, the second parameter, and the third parameter;
obtain a color adjusted image portion based on a combination of the color adjusted first parameter, the color adjusted second parameter, and the color adjusted third parameter;
include the color adjusted image portion in a color adjusted image; and
transmit or store the color adjusted image.

11. The image capture apparatus of claim 10, wherein the first parameter represents a first color component, the second parameter represents a second color component, and the third parameter represents a third color component.

12. The image capture apparatus of claim 11, wherein the first color component is a red color component, the second color component is a green color component, and the third color component is a blue color component.

13. The image capture apparatus of claim 10, wherein the image signal processor is configured to obtain the color adjusted first parameter from the first one-dimensional look-up table, a fourth one-dimensional look-up table, and a fifth one-dimensional look-up table.

14. The image capture apparatus of claim 13, wherein the image signal processor is configured to:
obtain a first component of the color adjusted first parameter from the first one-dimensional look-up table based on the first parameter;
obtain a second component of the color adjusted first parameter from the fourth one-dimensional look-up table based on the second parameter;
obtain a third component of the color adjusted first parameter from the fifth one-dimensional look-up table based on the third parameter; and
obtain a sum of the first component of the color adjusted first parameter, the second component of the color adjusted first parameter, and the third component of the color adjusted first parameter as the color adjusted first parameter.

15. The image capture apparatus of claim 10, wherein the image signal processor is configured to:
obtain the color adjusted second parameter from the second one-dimensional look-up table, a sixth one-dimensional look-up table, and a seventh one-dimensional look-up table.

16. The image capture apparatus of claim 15, wherein the image signal processor is configured to:
obtain a first component of the color adjusted second parameter from the second one-dimensional look-up table based on the first parameter;
obtain a second component of the color adjusted second parameter from the sixth one-dimensional look-up table based on the second parameter;
obtain a third component of the color adjusted second parameter from the seventh one-dimensional look-up table based on the third parameter; and
obtain a sum of the first component of the color adjusted second parameter, the second component of the color adjusted second parameter, and the third component of the color adjusted second parameter as the color adjusted second parameter.

17. The image capture apparatus of claim 10, wherein the image signal processor is configured to:
obtain the color adjusted third parameter from the third one-dimensional look-up table, an eighth one-dimensional look-up table, and a ninth one-dimensional look-up table.

18. The image capture apparatus of claim 17, wherein the image signal processor is configured to:
obtain a first component of the color adjusted third parameter from the third one-dimensional look-up table based on the first parameter;
obtain a second component of the color adjusted third parameter from the eighth one-dimensional look-up table based on the second parameter;
obtain a third component of the color adjusted third parameter from the ninth one-dimensional look-up table based on the third parameter; and
obtain a sum of the first component of the color adjusted third parameter, the second component of the color adjusted third parameter, and the third component of the color adjusted third parameter as the color adjusted third parameter.

19. A method comprising:
receiving, by an image signal processor, an input image;
obtaining, by the image signal processor, an input image portion from the input image;
obtaining, by the image signal processor, a color adjusted image portion based on the input image portion by:
obtaining a value for the input image portion wherein the value is expressed as a combination of at least a first parameter, a second parameter, and a third parameter;
obtaining a first component of a first color adjusted parameter from a first one-dimensional look-up table based on the first parameter;
obtaining a second component of the first color adjusted parameter from a second one-dimensional look-up table based on the second parameter;
obtaining a third component of the first color adjusted parameter from a third one-dimensional look-up table based on the third parameter;
obtaining a mathematical combination of the first component of the first color adjusted parameter, the second component of the first color adjusted parameter, and the third component of the first color adjusted parameter as a first color adjusted parameter;
obtaining a first component of a second color adjusted parameter from a fourth one-dimensional look-up table based on the first parameter;
obtaining a second component of the second color adjusted parameter from a fifth one-dimensional look-up table based on the second parameter;
obtaining a third component of the second color adjusted parameter from a sixth one-dimensional look-up table based on the third parameter;
obtaining a mathematical combination of the first component of the second color adjusted parameter, the second component of the second color adjusted parameter, and the third component of the second color adjusted parameter as a second color adjusted parameter;
obtaining a first component of a third color adjusted parameter from a seventh one-dimensional look-up table based on the first parameter;
obtaining a second component of the third color adjusted parameter from a eighth one-dimensional look-up table based on the second parameter;
obtaining a third component of the third color adjusted parameter from a ninth one-dimensional look-up table based on the third parameter;
obtaining a mathematical combination of the first component of the third color adjusted parameter, the second component of the third color adjusted parameter, and the third component of the third color adjusted parameter as a third color adjusted parameter; and
obtaining the color adjusted image portion based on a combination of the first color adjusted parameter, the second color adjusted parameter, and the third color adjusted parameter;
including, by the image signal processor, the color adjusted image portion in a color adjusted image; and
transmitting or storing, by the image signal processor, the color adjusted image.

20. The method of claim 19, wherein the first parameter represents a first color component, the second parameter represents a second color component, and the third parameter represents a third color component.
